(19) United States
(12) Patent Application Publication
(10) Pub. No.: US 2010/0045922 A1
(43) Pub. Date: Feb. 25, 2010

(54) LIQUID CRYSTAL DISPLAY DEVICE

(75) Inventor: Toshihiko Motomatsu, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD TECHNOLOGIES, LTD., Kawasaki (JP)

(21) Appl. No.: 12/542,421

(22) Filed: Aug. 17, 2009

(30) Foreign Application Priority Data
Aug. 22, 2008 (JP) 2008-213851

(51) Int. Cl. G02F 1/1339

(52) U.S. Cl. 349/156

(57) ABSTRACT

A liquid crystal display device includes a pair of substrates, liquid crystal material, a sealing member and pillar spacers. The substrates are provided with an alignment film respectively and the liquid crystal material is disposed between the substrates. The sealing member is provided between the substrates for sealing the liquid crystal material. The pillar spacers are provided on either one of the substrates and the pillar spacers includes asymmetric pillar spacers each having a major axis and a minor axis viewed from a normal direction of the substrates with a round front end and a sharp rear end of the major axis. The asymmetric pillar spacers are arranged on a pixel region in a vicinity of at least one corner of one of the substrates so that the rear end in a direction of the major axis is directed toward the corner.

This application is based upon and claims the benefit of priority from Japanese Patent Application No. 2008-213851, filed on Aug. 22, 2008, the disclosure of which is incorporated herein in its entirety by reference.

### TECHNICAL FIELD

The present invention relates to a liquid crystal display device and in particular, relates to a configuration of pillar spacers arranged between a pair of substrates.

### BACKGROUND ART

FIG. 16 is a sectional view indicating a structure of a related art liquid crystal display (LCD) panel. This LCD panel 12 includes a color filter (CF) substrate 3 and a thin film transistor (TFT) substrate 2. The CF substrate 3 is provided with a CF film and a black matrix (BM) film or the like. The TFT substrate 2 is provided with switching elements such as TFTs in a matrix shape. The CF substrate 3 is provided with pillar spacers 10 formed on the CF film. Each of the pillar spacers 10 has such a configuration as rectangular column, a cylindrical column and an ellipse.

The CF substrate 3 is provided with a frame-shaped black matrix (BM) film 7 made of either an organic film or an inorganic film is formed on a frame like peripheral area of the CF substrate 3. The TFT substrate 2 is also provided with either the organic film or the inorganic film on a frame like peripheral area thereof. These substrates are respectively provided with at least an alignment film 8 processed with an alignment treatment on a pixel region (or a display area).

One of the substrates opposing each other is provided with sealing material 11 so that the two substrates are bonded together with a predetermined gap maintained by the pillar spacers 10 to dispose liquid crystal material 4 between them.

FIG. 17A indicates a plan view of a related art LCD panel 12, and FIG. 17B shows a partial enlarged plan view of an upper right portion of FIG. 17A to indicate a forming area of the pillar spacers 10. In the related art, the pillar spacers 10 each having such shape as a rectangular column, a cylindrical column or an ellipse are formed on the CF film 6 in the pixel region 16 of the CF substrate 3 of the LCD panel 12. As shown in FIG. 17, for example, cylindrical column-shaped pillar spacers 10 are uniformly formed on an entire area of pixels so as to only maintain the predetermined gap (refer to Japanese Patent Application Laid-Open No. 2002-169165 (patent document 1)).

Recently, however, various types of pillar spacers are proposed with other purposes such as means for maintaining the gap in an area besides the pixel region 16 and means for not giving damage to the rubbing cloth. For example, streamline pillar spacers are disclosed in Japanese Patent Application Laid-Open No. 2007-206713 (patent document 2) and dome-shaped pillar spacers are disclosed in Japanese Patent Application Laid-Open No. 2007-240599 (patent document 3). However, these patent documents 2 and 3 do not indicate particularly about arrangement directions of the pillar spacers.

FIG. 18A is a plan view showing a state of a dispensing area 41 just after dispensing the liquid crystal material on a substrate of the LCD panel in a related art. FIG. 18B is a plan view showing a state after the liquid crystal material shown in FIG. 18A spreads. In the related art, because the pillar spacers, each of which has a shape like a rectangular column, a cylindrical column or an ellipse, are formed on an entire area of pixels uniformly, an arrival time of the liquid crystal material 4 to a vicinity of a coated part of the sealing material 11 is different between a panel side part and a panel corner part within a closed curve-like coated area of the sealing material 11. In other words, as shown in FIG. 18B, the liquid crystal material 4 does not spread over the whole panel uniformly, and thus a part of the liquid crystal material 4 reaches the coated part of the sealing material 11 in an uncured state to cause a contacted part 114. As a result, contacted state between the liquid crystal material 4 and the sealing material 11 is maintained and thereby generating display defect at the contacted part 114.

This is because the substance which pollutes the liquid crystal material is eluted from the sealing material due to contact between the liquid crystal material and uncured sealing material. As to the substance eluted from the uncured sealing material to pollute the liquid crystal material, such organic material as oligomer ingredient and phthalic acid ester, and ionicity impurities of Na, K and Cl can be listed. The amount of eluted substances which pollute the liquid crystal material is proportional to duration of contact between the uncured sealing material and the liquid crystal material, and it is known that when the contact time becomes long, the eluted amount tends to increase rapidly. Therefore, the contact between the uncured sealing material and the liquid crystal material needs to be suppressed as much as possible.

To deal with this problem, it is conventionally tried to control a pattern of a dispensing position of the liquid crystal material. Instead of forming a matrix-like pattern by making a distance between the dispensing position and the seal-coated part constant, Japanese Patent Application Laid-Open No. 2004-4448 (patent document 4) indicates to form a so-called dumbbell-like pattern by changing distance between the dispensing positions and the seal-coated parts. That is, the dispensing position of the liquid crystal material is controlled such that at the panel corner areas, where the arrival time to a vicinity of the seal-coated part is long, its dispensing position is located so as to be close to the seal-coated part, while at panel side areas, where the arrival time to a vicinity of the seal-coated part is short, its dispensing position is located so as to be away from the seal-coated part.

Furthermore, there is another technology to solve the similar technical issue by designing arrangement and shape of the pillar spacers. That is, Japanese Patent Application Laid-Open No. 2003-107492 (patent document 5) discloses a method to form cylindrical column-shaped pillar spacers instead of forming rectangular column-shaped pillar spacers on a non-display area which is not responsible for a display in a pixel region.

Moreover, Japanese Patent Application Laid-Open No. 2007-047280 (patent document 6) discloses a method to form pillar spacers of ellipse like or rectangular column like (oblong) on a area in the vicinity of corner part of the sealing material instead of forming square column-shaped pillar spacers.

However, when the pattern of the dispensing position of the liquid crystal material is made to be the dumbbell-like pattern as in the case of the patent document 4, it is difficult to control a spreading direction of the liquid crystal material within the bonded substrates in a desired direction. As a result, the liquid crystal material cannot be made spread over the entire panel uniformly. This is because, a control method owing to the pattern of the dispensing position does not control a spreading direction and its spreading speed of the liquid crystal material in a state that the substrates are bonded together after dispensing the liquid crystal material on one of the substrates.

In addition, this method has a new issue which has to control a drip amount of the liquid crystal material in a small quantity. In that situation, when the small quantity dispensing of the liquid crystal material is performed in this way, it takes a long dispensing time, and a dispensing precision of pumping equipment tends to deteriorate in its ability, and thereby causing such problem that the variation in the enclosed capacity of the liquid crystal material becomes large. As a result, a fluctuation of gap variation becomes large, and thereby causing such problem that a display quality declines.

In a solution method owing to the pattern of the dispensing position of the liquid crystal material, it is necessary to control a small amount of drop of the liquid crystal material to the vicinity of seal-coated part in the panel corner areas which requires long time in particular for spreading the liquid crystal material. In this method, the dispensing time of the liquid crystal material becomes longer, and moreover, the fluctuation of gap variation tends to become large.

The patent document 5 discloses that when the cylindrical column-shaped pillar spacers are used instead of using the rectangular column like spacers, an injection time of the liquid crystal material can be made short without generating air bubbles by respectively smoothing flows of the air and the liquid crystal material in the vicinity of the pillar spacers during injecting the liquid crystal material into the panel by vacuum suction of the liquid crystal injection process.

However, just forming the cylindrical column-shaped pillar spacers instead of the rectangular column-shaped pillar spacers, spreading direction of the liquid crystal material within the panel cannot be controlled in an intended direction and thus the liquid crystal material cannot be spread within the entire panel uniformly and efficiently. This is because the spreading of the liquid crystal material is not restricted by an arrangement direction and a forming area of the pillar spacers in this method, and thus it does not control the spreading direction and spreading speed of the liquid crystal material.

In the patent document 6, it is disclosed that the pillar spacers of the ellipse like or the rectangular column like (oblong) enable to prevent a disturbance of spreading the liquid crystal material compared with the square column like. However, such pillar spacers unable to keep its initial shape when they are sandwiched between two substrates, and result in such shape of being crushed and spread. Therefore, even if its shape seems to be easy to spread the liquid crystal material in a plan view, as far as its manufacturing method is resorted to an injection method by injecting and spreading the liquid crystal material into the panel which is made by bonding the two substrates together, it is not easy to control the spreading direction and its uncured spreading speed of the liquid crystal material. Accordingly, the pillar spacers has to be designed in consideration of its shape changing due to contact and pressure caused by bonding the CF substrate and the TFT substrate together.

### SUMMARY

An exemplary object of the present invention is to provide an LCD device which can suppress the contamination of the liquid crystal material caused by contacting liquid crystal material with sealing material when the liquid crystal material does not uniformly spread over an entire panel.

A liquid crystal display device according to an exemplary aspect of the invention includes a pair of substrates, liquid crystal material, a sealing member and pillar spacers. The substrates are provided with an alignment film respectively and the liquid crystal material is disposed between the substrates. The sealing member is provided between the substrates for sealing the liquid crystal material. The pillar spacers are provided on either one of the substrates and the pillar spacers includes asymmetric pillar spacers each having a major axis and a minor axis viewed from a normal direction of the substrates with a round front end and a sharp rear end of the major axis. The asymmetric pillar spacers are arranged on a pixel region in a vicinity of at least one corner of one of the substrates so that the rear end in a direction of the major axis is directed toward the corner.

### BRIEF DESCRIPTION OF THE DRAWINGS

Exemplary features and advantages of the present invention will become apparent from the following detailed description when taken with the accompanying drawings in which:

FIG. 1 is a sectional view showing a configuration of an LCD panel of a first exemplary embodiment of the present invention;

FIG. 2A, FIG. 2C, FIG. 2E, and FIG. 2G are plan views respectively showing a shape example of a pillar spacer in the LCD panel of the first exemplary embodiment of the present invention;

FIG. 2B, FIG. 2D, FIG. 2F and FIG. 2H are sectional views taken along the I-I line shown in FIG. 2A, FIG. 2C, FIG. 2E and FIG. 2G, respectively;

FIG. 3A, FIG. 3C and FIG. 3E are plan views respectively showing a shape example of a pillar spacer in a related art LCD panel;

FIG. 3B, FIG. 3D and FIG. 3F are sectional views taken along the II-II line shown in FIG. 3A, FIG. 3C and FIG. 3E, respectively;

FIG. 4A is a characteristic diagram showing relation between an elapsed time after bonding two substrates and a reached distance of liquid crystal material in various shapes of pillar spacers;

FIG. 4B is a schematic plan view showing the reached distance “d” shown in FIG. 4A;

FIG. 5A, FIG. 5C and FIG. 5E are plan views respectively showing a forming area of the pillar spacers in the LCD panel of the first exemplary embodiment of the present invention;

FIG. 5B, FIG. 5D and FIG. 5F are enlarged plan views at upper right portions shown in FIG. 5A, FIG. 5C and FIG. 5E, respectively;

FIG. 6A through FIG. 6C are schematic plan views respectively showing an arrangement direction example of the pillar spacers in the LCD panel of the first exemplary embodiment of the present invention;

FIG. 7A through FIG. 7C are schematic plan views respectively showing a forming area of pillar spacers in an LCD panel of a second exemplary embodiment of the present invention;

FIG. 8A through FIG. 8C are schematic plan views respectively showing a forming area of pillar spacers in an LCD panel of a third exemplary embodiment of the present invention;

FIG. 9A and FIG. 9C are plan views respectively showing a forming area of the pillar spacers in the LCD panel of a fourth exemplary embodiment of the present invention;

FIG. 9B and FIG. 9D are enlarged plan views at upper right portions shown in FIG. 9A and FIG. 9C, respectively;

FIG. 10A is a plan view showing a forming area of the pillar spacers in the LCD panel of a fifth exemplary embodiment of the present invention;

FIG. 10B is an enlarged plan view at an upper right portion shown in FIG. 10A;

FIG. 11A is a plan view showing a forming area of the pillar spacers in the LCD panel of a sixth exemplary embodiment of the present invention;

FIG. 11B is an enlarged plan view at an upper right portion shown in FIG. 11A;

FIG. 12A is a plan view showing forming areas of the pillar spacers in the LCD panel of a seventh exemplary embodiment of the present invention;

FIG. 12B is an enlarged plan view at an upper right portion shown in FIG. 12A;

FIG. 12C is an enlarged plan view at a middle right portion shown in FIG. 12A;

FIG. 13 is a schematic plan view showing a forming area of the pillar spacers in the LCD panel of the seventh exemplary embodiment of the present invention;

FIG. 14A is a plan view showing forming areas of the pillar spacers in the LCD panel of an eighth exemplary embodiment of the present invention;

FIG. 14B is an enlarged plan view at an upper right portion shown in FIG. 14A;

FIG. 14C is an enlarged plan view at a lower right portion shown in FIG. 14A;

FIG. 14D is an enlarged plan view at a vicinity of an opening for injecting liquid crystal material shown in FIG. 14A;

FIG. 14E is a plan view showing forming areas of the pillar spacers in a related art for comparison;

FIG. 15A is a plan view showing a state in the LCD panel of the present invention when two substrates are bonded together after dispensing liquid crystal material;

FIG. 15B is a plan view showing a state after the liquid crystal material shown in FIG. 15A spreads.

FIG. 16 is a sectional view showing a configuration of a related art LCD panel;

FIG. 17A is a plan view showing an LCD panel in a related art;

FIG. 17B is an enlarged plan view of an array of pillar spacers at an upper right portion shown in FIG. 17A;

FIG. 18A is a plan view showing a state just after dispensing liquid crystal material on the LCD panel in a related art; and

FIG. 18B is a plan view showing a state after the liquid crystal material shown in FIG. 18A spreads.

### EXEMPLARY EMBODIMENT

Next, a detailed explanation will be given for a first exemplary embodiment with reference to the drawings.

As described in the background art, when the CF substrate and the TFT substrate for the LCD device are bonded together after dispensing liquid crystal material on either one of the substrates coated with an alignment film and sealing material, there is a difference in an arrival time of the liquid crystal material spreading toward different parts of the seal-coated part located at the panel side parts and the panel corner parts.

Owing to this arrival time difference, the liquid crystal material does not spread uniformly toward the vicinity of the seal-coated part, and particularly, it requires more time to reach the seal-coated part in the vicinity of the panel corner parts. For this reason, during the bonded substrates are stand by state so that the liquid crystal material spreads over the entire panel, the liquid crystal material reaches the uncured seal-coated part firstly, and thereby causing display defect at that portion due to unwanted eluted ingredient in the sealing material.

In order to solve this problem, the pillar spacers in the pixel region of at least one panel corner part is made streamline shape or drop of water type by which the liquid crystal material tends to be spread in the designated direction. As a result, it is possible to provide a high-quality LCD device with remarkably improved reliability by preventing the occurrence of the display defect in the part where the liquid crystal material reaches the uncured seal-coated part faster than the other part. It will be described in detail with reference to the drawings in the followings.

### Exemplary Embodiment 1

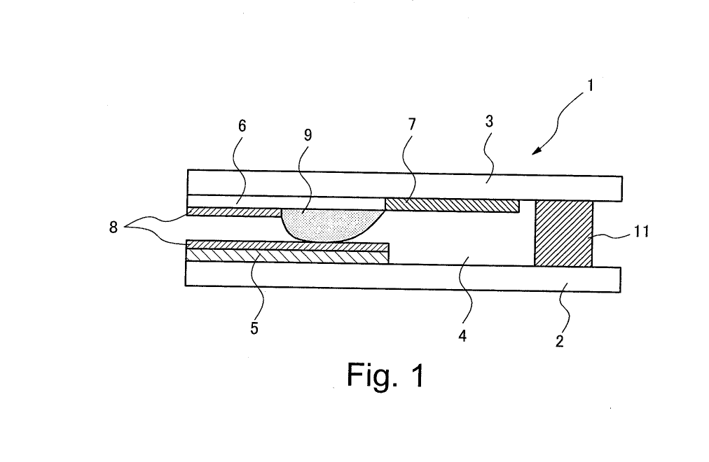

FIG. 1 is a sectional view showing a configuration of an LCD panel of a first exemplary embodiment of the present invention. This LCD panel 1 includes a CF (color filter) substrate 3 provided with a CF film 6 and a BM (black matrix) film 7 or the like, and a TFT substrate 2 provided with a driving circuit layer 5 having switching elements such as thin film transistors arranged in a matrix pattern. On the CF film 6 of the CF substrate 3, pillar spacers 9 each having a shape like a streamline shape or a drop of water type by which more liquid crystal material 4 tend to be spread in a designated direction in a certain area are formed other than pillar spacers each having such a shape as rectangular column like or cylindrical column like or ellipse like.

The TFT substrate 2 is provided with a frame-shaped BM film 7 made of either an organic film or an inorganic film on a frame like peripheral area thereof. The TFT substrate 2 is provided with either the organic film or the inorganic film on a frame like peripheral area thereof. These substrates have pixel regions (display areas) each of which is provided with an alignment film 8 which is processed by at least alignment treatment. Both substrates are bonded together with sealing material 11 formed on either one of the opposing substrates. Opposing two substrates are spaced apart each other with a predetermined gap which is determined by the pillar spacers and the liquid crystal material 4 disposed between the two substrates.

As an example of the panel assembly step flow for the LCD panel of the above-mentioned structure, in a step of washing and drying for the substrates carried therein, washing and drying processes are carried out to clean the surfaces of the CF substrate and the TFT substrate.

Next, in a step for printing the alignment film (or an ink jet coating step), alignment material is coated on the substrate surfaces and then baked to form the alignment film. Next, in a rubbing treatment step, the alignment film is subjected to the rubbing treatment in order to control liquid crystal molecular orientation (this treatment is unnecessary in the case of the LCD panel of a VA (Vertical Alignment) mode).

Next, in a step of another washing and drying (washing and drying the substrates after the rubbing treatment), in order to remove fiber of a rubbing cloth, wastes of the alignment film, and impurities or the like which adhered during or between processing steps, additional washing and drying process are performed.

After that, in a seal-coating step, a sealing material is coated on a predetermined position of the TFT substrate to form a peripheral seal as an auxiliary seal and a closed curve-like seal as a main seal, respectively. Successively, in an Ag (silver) coating step, the Ag transfer-electrodes are provided on predetermined positions of the substrate in a dotted pattern (it would be employed in the case of the LCD panel with a TN (Twisted Nematic) mode).

Next, in a liquid crystal dispensing step, a predetermined drip amount of the liquid crystal material is dropped on predetermined positions inside the main seal with a pattern such as a matrix-like, linear-like and a radial-like.

After that, although the CF substrate and the TFT substrate are bonded together, the pillar spacers for forming the predetermined gap between the substrates are being arranged in the pixel region of the CF substrate in advance. And by touching and pressurizing the two substrates in the bonding process, the gap between the substrates is made uniform while spreading the liquid crystal material over entire area of the pixel region.

And then, during the substrates are conveyed to a next step, in order to prevent the fitting displacement in the bonded substrates, several temporary ultraviolet (UV) curing are being performed partially as a tentative fixing of the sealing material. In a next UV curing step, the sealing material is cured by performing the UV irradiation on a whole sealing material, and then in a next heat curing step, the sealing material is totally cured.

In the step of bonding two substrates after dispensing the liquid crystal material, the liquid crystal material dropped in the pixel region tends to spread to entire area of the pixel region during the bonding step after dispensing of the liquid crystal material. However, the liquid crystal material does not spread uniformly until it reaches the vicinity of the seal-coated part due to the difference in its arrival time of the liquid crystal material. Particularly, in the panel corner part, it requires longer arrival time for the liquid crystal material to reach the vicinity of the seal-coated part.

During the bonded substrates are stand by state so that the liquid crystal material spreads over the entire panel in order to provide a uniform gap between the substrates, the liquid crystal material reaches the uncured seal-coated part firstly, and thereby developing to the problem of generating display defect at that portion due to unwanted eluted ingredient in the sealing material.

One of the reasons of the above-mentioned different arrival times is that the seal-coated part at the panel corner has a longer distance from the dispensing position of the liquid crystal material in the pixel region compared with that of the seal-coated part at the panel side part.

Accordingly, in order to prevent the display defect owing to the above-mentioned cause, each of the pillar spacers in the pixel region of at least one panel corner part is made streamline shape or drop of water type by which the liquid crystal material tends to be spread in the designated direction. Changing the spacer shape to be this streamline shape or drop of water type, the liquid crystal material spread over smoothly along the spacer surface without being obstructed by the spacer itself compared with such pillar spacers as the rectangular column like, the cylindrical column like or the ellipse. Even if the shape of each pillar spacer is cylindrical or elliptical, the spreading of the liquid crystal material is somewhat obstructed. This is because, when the rounded part exists in such a manner that it is shadowed by the rear end of the pillar spacer against the liquid crystal material flowed from the front, detaching of the flow, i.e., a phenomenon of consuming time for a wraparound of the liquid crystal material, is caused.

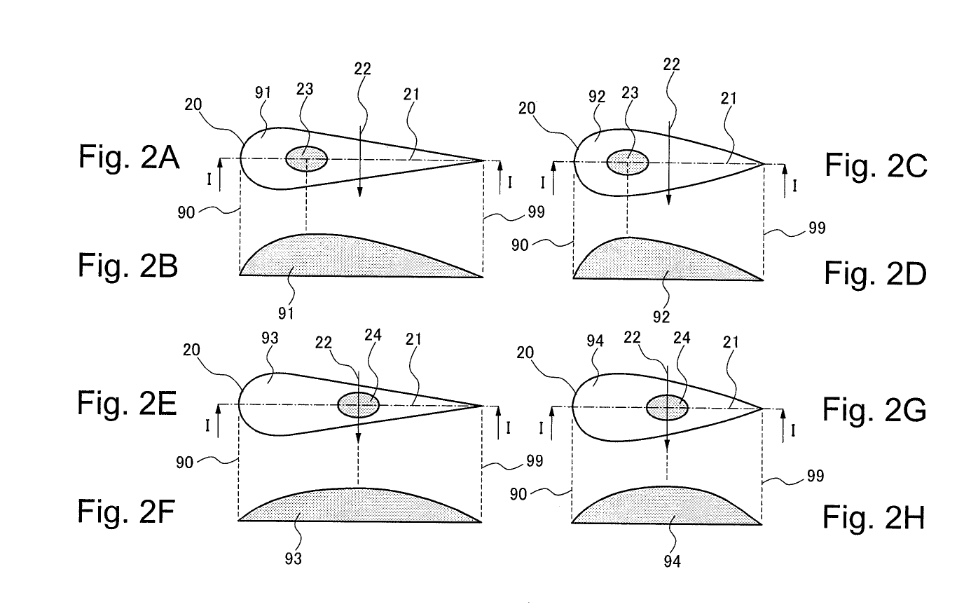

Various shape examples for each pillar spacer related to the first exemplary embodiment of the present invention are shown in FIG. 2. FIG. 2A, FIG. 2C, FIG. 2E, and FIG. 2G are plan views (seen from a direction normal to the substrate) respectively showing a shape example of a pillar spacer in the LCD. FIG. 2B, FIG. 2D, FIG. 2F and FIG. 2H are sectional views taken along the I-I line shown in FIG. 2A, FIG. 2C, FIG. 2E and FIG. 2G, respectively.

A streamline pillar spacer 91 is shown in FIG. 2A and FIG. 2B, and a water-drop type pillar spacer 92 is shown in FIG. 2C and FIG. 2D. Another streamline pillar spacer 93 is shown in FIG. 2E and FIG. 2F, and another water-drop type pillar spacer 94 is shown in FIG. 2G and FIG. 2H. Each of these spacers has a shape that makes the flow of the liquid crystal material smooth and has a major axis and a minor axis. A direction of the major axis is a lengthwise direction of the pillar spacer when the pillar spacer is seen from a normal direction of the substrate, and a direction of the minor axis is a direction crossing at right angles with the direction of the major axis.

The pillar spacer 9 has a slender shape as shown in the plan views of FIG. 2A, FIG. 2C, FIG. 2E and FIG. 2G. Each of these spacers of streamline or the water-drop type is made to have a shape narrowed down gently so that the liquid crystal material may smoothly flow in the pillar spacer forming area and flow out. Here, it is shown that the liquid crystal material flows from the left side to the right side of an arrow 21 of the major axis direction. Hereinafter, the left side of the spacer where the liquid crystal material flows in is called a front end of the spacer, and the right side of the spacer where the liquid crystal material flows out is called a rear end of the spacer.

Each of the streamline pillar spacers 91 and 93 shown in FIG. 2A and FIG. 2E, respectively, is slender asymmetric shape as a whole body such that its front end is round (the left side of the drawings) and its rear end is sharp (the right side of the drawings).

Each of the water-drop type pillar spacers 92 and 94 shown in FIG. 2C and FIG. 2G, respectively, is slender asymmetric shape as a -whole body such that its front end is round (the left side of the drawings) and its rear end is sharp (the right side of the drawings). However, the width of the water-drop type pillar spacers 92 and 94 along an arrow 22 of the minor axis direction is made larger than that of the streamline pillar spacers 91 and 93. With such shape, the liquid crystal material smoothly flows along the pillar spacer 9 from the front end to the rear end of it.

For example, in the case of the examples shown in the cross-sectional views in FIG. 2B and FIG. 2D, each upper base part of the streamline pillar spacer 91 and the water-drop type pillar spacer 92 is like a hill, and its vertex part 23 is located in a side of the front end 90, that is, a side of the circular face 20 (a side that receives the flow of the liquid crystal material first) from a center of each of the pillar spacers 91 and 92. In this case, the vertex part 23 of the upper base part may be either sharp or flat, and it should be set appropriately according to a product design.

In the case of the examples shown in the cross-sectional views in FIG. 2F and FIG. 2H, each upper base part of the streamline pillar spacer 93 and the water-drop type pillar spacer 94 is like a hill, and its vertex part 24 is located in a center of each of the pillar spacers 93 and 94. In this case, the vertex part 24 of the upper base part may be either sharp or flat like in the case shown in FIG. 2B and FIG. 2D, and it should be set appropriately according to a product design.

Although a side part extending in the major axis direction of the pillar spacer shown in FIG. 2A through FIG. 2H will be a gentle curved shape, a part of it may be a flat shape.

As to the position of the vertex part, the position of the vertex part 23 shown in FIG. 2A and FIG. 2C is more desirable than that of the vertex part 24 located in the center as indicated in FIG. 2E and FIG. 2G. Accordingly, the position of the vertex part is set within a range from the pillar spacer center to the front end 90 of the side of the circular face 20 of it.

The reason of setting the position of the vertex part within the above-mentioned range is that the smooth spreading of the liquid crystal material is not obstructed in the state that the substrates are bonded together. When the CF substrate and the TFT substrate are bonded together, the two substrates are contacted and pressurized. For this reason, deformation occurs around the vertex part (the contacted part with the opposing substrate) of the pillar spacer and thus the initial shape of the pillar spacer changes. When the position of the vertex part is located within the above-mentioned range and the shape of the rear end of the pillar spacer is the shape narrowed down gently, the rear end shape where the liquid crystal material flows out does not change. Therefore, the liquid crystal material is spreading more smoothly without consuming time for the wraparound time at the rear end of the pillar spacer.

In contrast, in the related art pillar spacers having such shape as the rectangular column like, the cylindrical column like and the elliptical like, all over around the vertex part of the upper base part will be deformed, and the rear end shape of the pillar spacers changes greatly. Examples of the pillar spacers of the related art are shown in FIG. 3A to FIG. 3F for comparison.

FIG. 3A, FIG. 3C and FIG. 3E are plan views showing an elliptical pillar spacer 101, a cylindrical column-shaped pillar spacer 102 and a rectangular column-shaped pillar spacer 103 in the related art LCD panel, respectively. FIG. 3B, FIG. 3D and FIG. 3F are sectional views taken along the line II-II in FIG. 3A, FIG. 3C and FIG. 3E, respectively. In these related art pillar spacers, in general, each vertex part 30 of an upper base part of the pillar spacers is usually located at its center. Therefore, all over around the vertex part 30 is deformed by bonding the substrates together, and thus both of the shapes of the front end 100 and the rear end 109 of the pillar spacer will be deformed and expanded. For this reason, the area 35 which consumes time for the wraparound of the liquid crystal at respective back ends 109 of the pillar spacers such as rectangular column like, the cylindrical column like and the elliptical like.

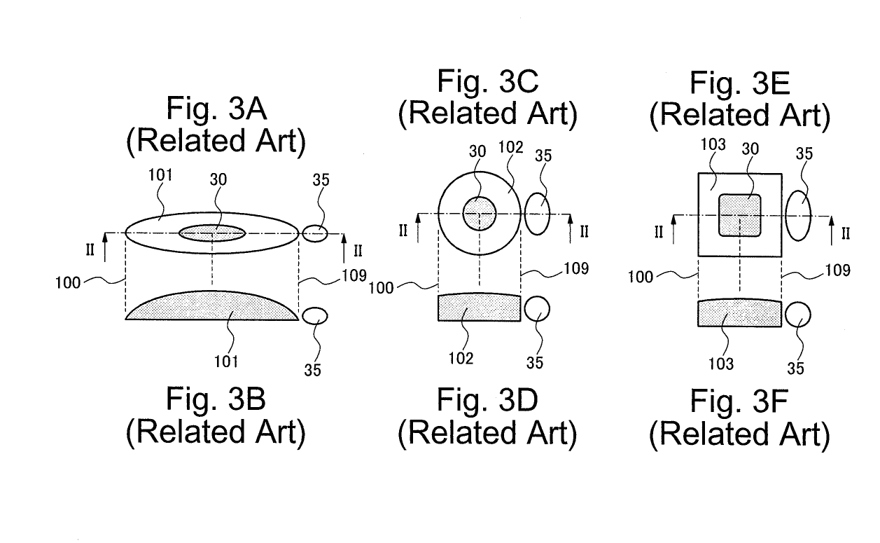

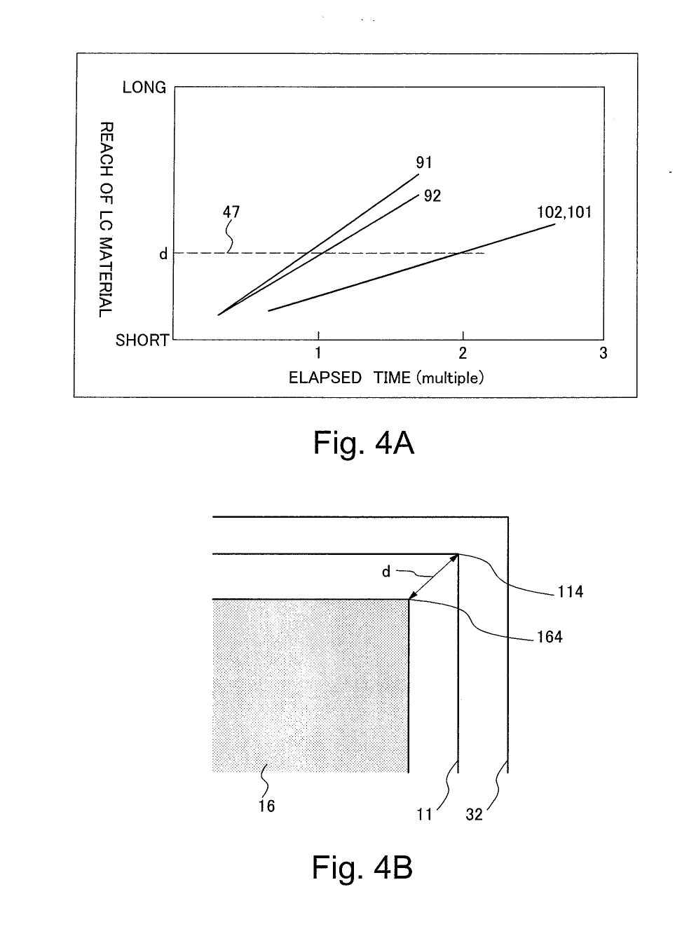

Next, regarding the pillar spacers of the streamline shape, the water-drop type, the cylindrical column like, and the elliptical, FIG. 4A shows a characteristic diagram comparing a reach of the liquid crystal (LC) material as indicated in a vertical axis (a distance from a dispensing area to a seal-coated part covered by the liquid crystal material) to an elapsed time (multiple) after the substrates are bonded together indicated in a horizontal axis. Here, in the streamline pillar spacer 91 and the water-drop type pillar spacer 92 according to the exemplary embodiment of the present invention, the relation between the reach and the elapsed time is indicated when the liquid crystal material is flowing along the major axis direction 21 shown in FIG. 2 to which the liquid crystal material spreads easily. Regarding the reach of the liquid crystal material, as shown in FIG. 4, the liquid crystal material tends to spread easily in the order of following inequality: the streamline shape 91>the water-drop type 92>>the cylindrical column like 102 and the ellipse like 101. Therefore, the streamline pillar spacer 91 and the water-drop type pillar spacer 92 have shape that makes the flow of the liquid crystal material smooth compared with the related art cylindrical column like pillar spacer 102 and the elliptical pillar spacer 101.

Further, in the case of the related art rectangular column-shaped pillar spacer 103, the liquid crystal material also becomes difficult to spread compared with the cylindrical column like and the ellipse like. When the liquid crystal material is flowing to the minor axis direction 22 (referred to FIG. 2) of the pillar spacer of the exemplary embodiment of the present invention (it is difficult for the liquid crystal material to spread), the liquid crystal material also becomes more difficult to spread compared with the rectangular column like spacer.

In FIG. 4A, when spreading state of the liquid crystal material is compared based on the reach (d) of the liquid crystal material about a certain product “A” as an example, the pillar spacer according to the present invention enables to make the liquid crystal material to be spread in a designated direction in about half time of the case of either the cylindrical column like pillar spacer or the elliptical pillar spacer. As shown in FIG. 4B, the reach (d) of this liquid crystal material is the distance between the corner part 164 of the pixel region 16 and the corner part 114 of the sealing material 11.

In order to half-cure the seal material before the liquid crystal material reaches the uncured seal, the seal material must be half-cured by UV radiation within 5 to 7 minutes after starting the bonding process for the substrates provided with dispensed liquid crystal material. Concerning such case in a related art, when it needs 15 minutes to reach the corner parts, the liquid crystal material reaches the uncured seal at the side part in 4 minutes. On the other hand, in the present invention, the liquid crystal material reaches to the corner parts within 7 minutes while it reaches to the side parts in 6 to 7 minutes due to the above-mentioned delay. Accordingly, the arrival time of the liquid crystal material to entire areas becomes equalized, and thereby avoiding the contact between the liquid crystal material and the uncured seal at their shortest distance parts.

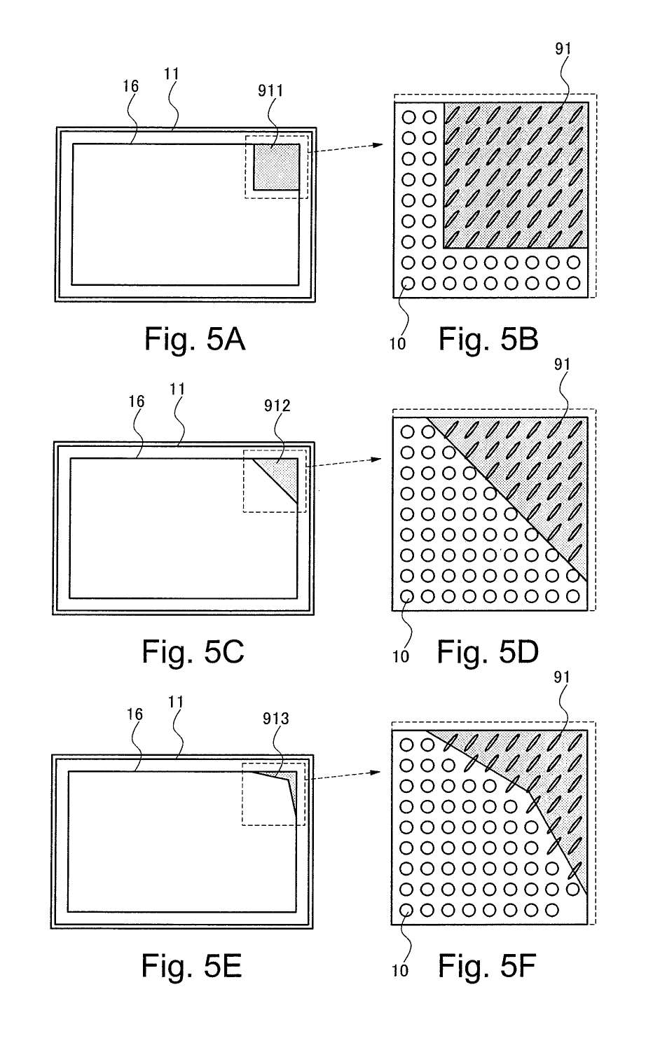

FIG. 5A, FIG. 5C and FIG. 5E are plan views respectively showing a forming area of the pillar spacers in the LCD panel of the first exemplary embodiment of the present invention. FIG. 5B, FIG. 5D and FIG. 5F are enlarged plan views at upper right portions shown in FIG. 5A, FIG. 5C and FIG. 5E, respectively. The pillar spacers are formed on the CF film in the pixel region 16 of the CF substrate of the LCD panel.

In an example shown in FIG. 5, the area which forms the streamline pillar spacers 91 is located at one of four corners of the panel. A spacer forming area 911 in FIG. 5A has a shape of a rectangular at an upper right corner. In FIG. 5C and FIG. 5E, a triangle-like spacer forming area 912 and an arrow-shaped spacer forming area 913 are provided at the upper right corner, respectively. As for the spacer forming area 913 with the arrow shape shown in FIG. 5E, it is made to have a quadrangle having total of four vertices located at a corner and its adjacent sides of the pixel region 16 and inside thereof. In addition to that, the quadrangle has a shape that its vertex opposing to the corner of the pixel region 16 is arranged such that it is located closer to the corner of the pixel region 16 than a line connecting two vertices on two sides of the pixel region. That is, it bends toward the corner of the pixel region 16.

Needless to say, the streamline pillar spacers 91 can be replaced with the water-drop type pillar spaces 92. As to an arrangement direction of either type of the streamline pillar spacers 91 or the water-drop type pillar spacers 92, the major axis direction of them is arranged so as to be directed toward the seal corner 114 (referred to FIG. 4B).

Regarding the forming area of the present pillar spacers, although the rectangle, the triangle and the arrow shape are shown as examples, the shapes of the forming areas should be made appropriately according to a product design. This concept can be applied to following other exemplary embodiments. For example, in FIG. 5A, although the forming area 911 of the present pillar spacers is made square, it will be made to be a rectangle according to a shape of the pixel region 16 such that a diagonal of the pixel region 16 is arranged so as to overlap a diagonal of the rectangle of the forming area 911.

In FIG. 5C, although the forming area 912 of the present pillar spacers is made to be an isosceles triangle having the corner of the pixel region 16 as a vertex, the length of two sides of which may be changed according to the shape of the pixel region 16 as mentioned above. The arrow shape shown in FIG. 5E is just an example. So long as a line connecting the two vertices of the pixel region 16 on the two sides is bended or curved toward the corner of the pixel region 16, its shape may be made polygon beyond the quadrangle.

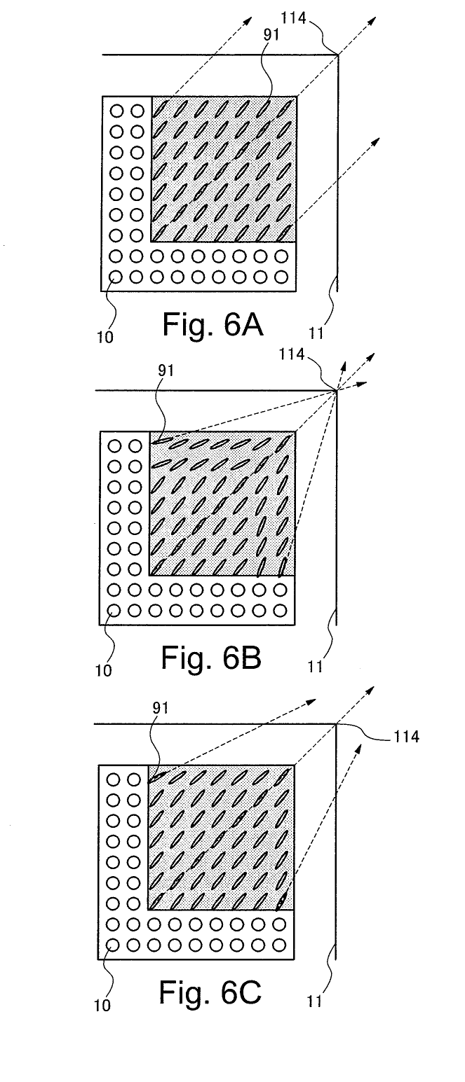

FIG. 6A through FIG. 6C are schematic plan views respectively showing an arrangement direction example of the pillar spacers in the LCD panel of the first exemplary embodiment of the present invention. When the major axis direction of the pillar spacer 91 is arranged so as to be directed toward the seal corner area 114, there are many variation. For example, as shown in FIG. 6A, the major axis direction of each of the present pillar spacers is arranged parallel to a line connecting one of the present pillar spacers and the seal corner part 114. In FIG. 6B, the major axis direction of each of the present pillar spacers is arranged so as to be directed toward the seal corner part 114. In FIG. 6C, the major axis direction of each of the present pillar spacers is arranged so as to be the direction of the midway shown in FIG. 6A and FIG. 6B.

These arrangement directions should be set appropriately according to the product design. The present pillar spacers of the streamline shape and the water-drop type are arranged such that the liquid crystal material flows from the circular face and passes away toward the face narrowed down gently, i.e., the face without being shadowed by the liquid crystal. That is, the sharp rear end is placed so as to be directed toward the seal corner part 114. According to such arrangement, the liquid crystal material can spread smoothly at the panel corner part where the arrival time of the liquid crystal material is used to be late. As a result, it can be controlled so that the liquid crystal material may spread over the entire panel uniformly.

### Exemplary Embodiment 2

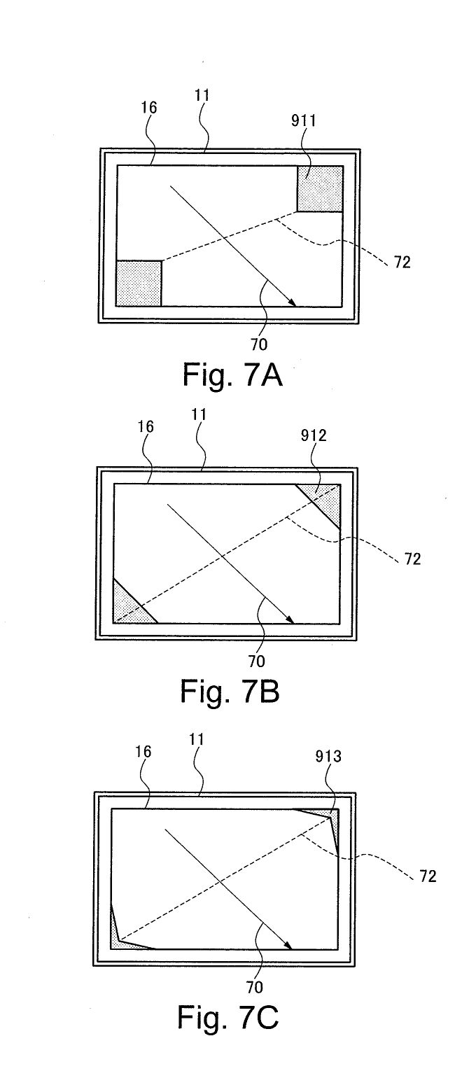

FIG. 7A through FIG. 7C are schematic plan views respectively showing an arrangement direction example of the pillar spacers in the LCD panel of a second exemplary embodiment of the present invention. The present pillar spacers are formed on a CF film in the pixel region 16 of the CF substrate of the LCD panel. In an example shown in FIG. 7, two areas for forming the streamline pillar spacers 91 are located at two of four corners of the panel. That is, present pillar spacers 91 are provided on a pair of panel corner parts located on an extended direction of a diagonal 72, which is one of two diagonals crossing a rubbing direction 70 with a larger crossing angle between them. A spacer forming area 911 in FIG. 7A has a shape of a rectangular at an upper right corner. In FIG. 7B and FIG. 7C, a triangle-like spacer forming area 912 and an arrow-shaped spacer forming area 913 are provided at the upper right corner, respectively. Needless to say, the streamline pillar spacer 91 can be replaced with the water-drop type pillar spacer 92. As to an arrangement direction of either type of the streamline pillar spacer 91 or the water-drop type pillar spacer 92, the major axis direction of them is arranged so as to be directed toward the seal corner 114 (referred to FIG. 4B). The present pillar spacers of the streamline shape and the water-drop type are arranged such that the liquid crystal material flows from the circular face and passes away toward the face narrowed down gently, i.e., the face without being shadowed by the liquid crystal material. That is, the sharp rear end is placed so as to be directed toward the seal corner part 114.

The reason of taking the foregoing structure is that the liquid crystal material tends to spread easily along the direction of the rubbing direction due to the fact that it tends to spread along fine grooves on the alignment film subjected to rubbing treatment. Although the rubbing direction 70 shown in FIG. 7 is applied to the TFT substrate, a similar treatment can be applied to a rubbing direction of the CF substrate. According to such arrangement, the liquid crystal material can spread smoothly at the panel corner part where the arrival time of the liquid crystal material is used to be late. As a result, it can be controlled so that the liquid crystal material may spread over the entire panel uniformly.

### Exemplary Embodiment 3

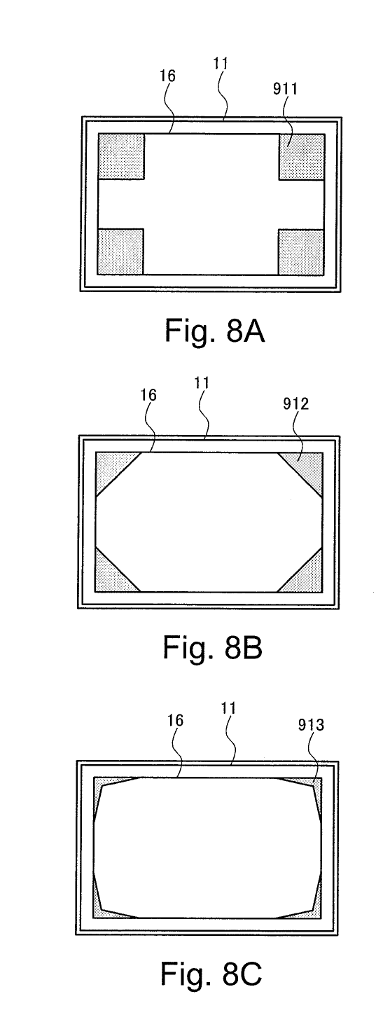

FIG. 8A through FIG. 8C are schematic plan views respectively showing a forming area of pillar spacers in an LCD panel of a third exemplary embodiment of the present invention. The present pillar spacers are formed on a CF film in the pixel region 16 of the CF substrate of the LCD panel. In an example shown in FIG. 8, two areas for forming the streamline pillar spacers 91 are located at four corners of the panel. A spacer forming area 911 in FIG. 8A has a shape of a rectangular at an upper right corner. In FIG. 8B and FIG. 8C, a triangle-like spacer forming area 912 and an arrow-shaped spacer forming area 913 are provided at the upper right corner, respectively. Needless to say, the streamline pillar spacer 91 can be replaced with the water-drop type pillar spacer 92. As to an arrangement direction of either type of the streamline pillar spacer 91 or the water-drop type pillar spacer 92, the major axis direction of them is arranged so as to be directed toward the seal corner 114 (referred to FIG. 4B). The present pillar spacers of the streamline shape and the water-drop type are arranged such that the liquid crystal material flows from the circular face and passes away toward the face narrowed down gently, i.e., the face without being shadowed by the liquid crystal. That is, the sharp rear end is located so as to be directed toward the seal corner part 114.

According to such arrangement, the liquid crystal material can spread smoothly at the panel corner part where the arrival time of the liquid crystal material is used to be late. As a result, it can be controlled so that the liquid crystal material may spread over the entire panel uniformly.

### Exemplary Embodiment 4

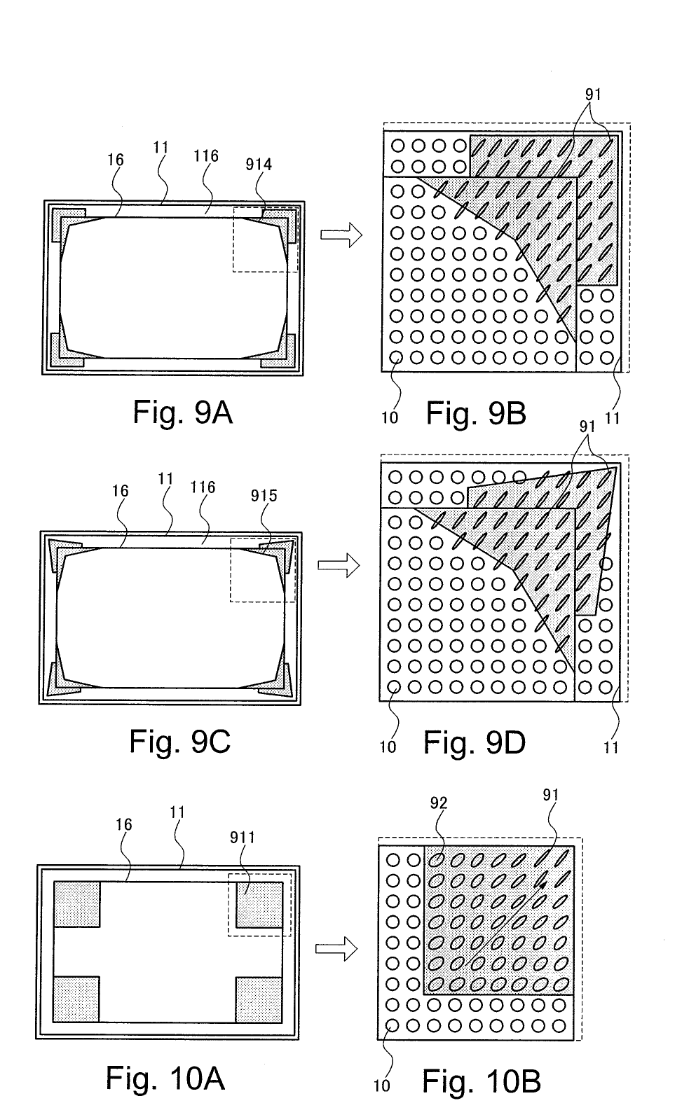

FIG. 9A and FIG. 9C are plan views respectively showing a forming area of the pillar spacers in the LCD panel of a fourth exemplary embodiment of the present invention. FIG. 9B and FIG. 9D are enlarged plan views at upper right portions shown in FIG. 9A and FIG. 9C, respectively. The present pillar spacers are formed on a CF film in the pixel region 16 of the CF substrate of the LCD panel. In a product having the pillar spacers provided on a frame-shaped BM (black matrix) area 116 formed between the pixel region 16 and the seal part 11, in addition to the third exemplary embodiment, either type of the streamline pillar spacer 91 or the water-drop type pillar spacer 92 can be formed on the four corner parts of the frame-shaped BM area 116. As an example of the shape of the forming area 914 of the present pillar spacers 91 or 92, it has a capital letter “L” type or an angle bracket type as shown in FIG. 9A and FIG. 9B. Another example is shown in FIG. 9C and FIG. 9D as a forming area 915 having an arrow shape.

The shape of the forming area 914 or 915 is nothing but examples, and thus it should be set appropriately according to the product design. For example, in FIG. 9A and FIG. 9B, although the length of two parts of the character “L” is made approximately same, each length may be changed according to the shape of the pixel region 16. In FIG. 9C and FIG. 9D, the forming area 915 with the arrow shape is made to be a hexagonal-shape having total of six vertices which include the corner of the pixel region 16, both sides of the corner, and three outside positions of the pixel region 16. And the angle of the vertex of the forming area 915 opposing to the corner of the pixel region 16 is made to become an acute angle. However, the above-mentioned angle of the vertex of the forming area 915 is not limited to that but it may be any shape so long as it has a projecting shape toward the panel corner part.

As to an arrangement direction of either type of the streamline pillar spacer 91 or the water-drop type pillar spacer 92, the major axis direction of them is arranged so as to be directed toward the seal corner 114 (referred to FIG. 4B). The present pillar spacers of the streamline shape and the water-drop type are arranged such that the liquid crystal material flows from the circular face and passes away toward the face narrowed down gently, i.e., the face without being shadowed by the liquid crystal. That is, the sharp rear end is placed so as to be directed toward the seal corner part 114.

By arranging the present pillar spacers within the pixel region 16 and in each of four corners of the frame-shaped BM area 116, it is possible to control so that the liquid crystal material may spread over the entire panel uniformly. Further, in case of other panel product such as the product with the design having a wide frame like peripheral area part, even if the pillar spacers such as the streamline shape and the water-drop type are arranged only to four positions of the corner of the frame-shaped BM area 116, the similar advantage can be obtained. The structure of this exemplary embodiment can also be applied similarly to the structure of the first and second exemplary embodiments.

### Exemplary Embodiment 5

FIG. 10A is a plan view showing a forming area of the pillar spacers in the LCD panel of a fifth exemplary embodiment of the present invention. FIG. 10B is an enlarged plan view at an upper right portion shown in FIG. 10A. The present pillar spacers are formed on a CF film in the pixel region 16 of the CF substrate of the LCD panel. Here, present pillar spacers are arranged on a forming area 911 of the present pillar spacers 91 and 92 at least one panel corner part in the pixel region 16. In FIG. 10A and FIG. 10B, the present pillar spacers are arranged at four corners. In this exemplary embodiment, the shapes of the present pillar spacers changes from the water-drop type pillar spacer 92 to streamline pillar spacer 91 in a step by step manner from inside to outside of the pixel region 16 to provide a so-called gradation arrangement.

As to an arrangement direction of either type of the streamline pillar spacer 91 or the water-drop type pillar spacer 92, the major axis direction of them is arranged so as to be directed toward the seal corner 114 (referred to FIG. 4B). The present pillar spacers of the streamline shape and the water-drop type are arranged such that the liquid crystal material flows from the circular face and passes away toward the face narrowed down gently, i.e., the face without being shadowed by the liquid crystal. That is, the sharp rear end is located so as to be directed toward the seal corner part 114. By such arrangement, spreading of the liquid crystal material can be controlled more delicately.

In FIG. 10A and FIG. 10B, the shape of the spacers changes from the water-drop type to another water-drop type with thin width along its minor axis direction, and then, further to the streamline shape in each of the quadrangle areas 911 at four corners within the pixel region 16. Further, in case of other panel having the frame-shaped BM area 116 like in the case shown in FIG. 9, the above-mentioned gradation arrangement can be applied to at least one area of each corner of the frame-shaped BM area 116 such that the shape of the spacers changes from the water-drop type to another water-drop type with thin width along its minor axis direction, and then, further to the streamline shape so as to obtain the similar advantage.

In FIG. 10A and FIG. 10B, although the forming area 911 of the present pillar spacers is made the rectangular shape, it can also be applied similarly to the triangle shape or the arrow shape.

### Exemplary Embodiment 6

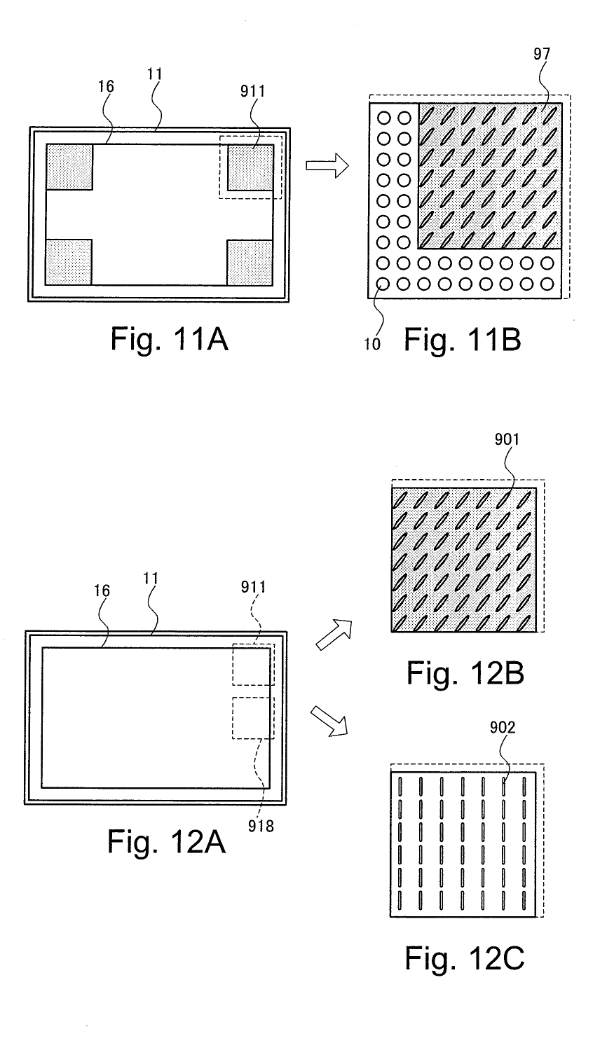

FIG. 11A is a plan view showing a forming area of the pillar spacers in the LCD panel of a sixth exemplary embodiment of the present invention and FIG. 11B is an enlarged plan view at an upper right portion shown in FIG. 11A. Pillar spacers 97 of the streamline shape or the water-drop type are arranged in at least one position (here, four positions) within the pixel region 16 of the panel corner part. The major axis direction of each pillar spacer 97 is being arranged directed toward the seal corner area. After arranging the pillar spacers 97, a non-repellent treatment is performed to the surface of the pillar spacers 97. That is, surface energy of the spacer surface is made large to improve the wettability to the liquid crystal material. Hereinafter, such treatment is called the non-repellent treatment.

Thus, the liquid crystal material can spread more smoothly along the spacer surface due to the non-repellent treatment. This process will be more effective means for an LCD panel based on a VA mode in which the liquid crystal material spread extremely slowly. The contained ingredient in the alignment material used for the VA mode is greatly different from the alignment material used for TN and IPS (In Plane Switching) modes such that its surface energy is lower than that of the alignment material used for the TN and IPS modes, and thus the liquid crystal material spreads slowly in the panel with the VA mode.

As for the non-repellent treatment, for example, there is a method to apply a short wavelength UV ray (172 nm) with a high energy by using excimer UV irradiation equipment. Or there is a method to irradiate plasma by using nitrogen gas or the like as a process gas in a plasma treatment apparatus such as a vacuum plasma treatment apparatus, an atmospheric pressure plasma treatment apparatus and a microwave plasma treatment apparatus. In particular, in the method of irradiating the plasma, the plasma processing can be performed in a pinpoint manner for the forming area 911 of the present pillar spacers by driving a plasma head in a scanning method. Therefore, the non-repellent treatment can be performed easily on the present pillar spacer surface of this area 911. Further, in the case of the sixth exemplary embodiment, it is preferable that the side surface along the major axis direction of the pillar spacer is made gentle curved surface in view of a high processing effect. Such non-repellent treatment should be carried out after the steps of washing and drying the substrates but just before forming the alignment film.

Although each of the forming areas 911 of the present pillar spacers 97 is made a rectangular shape in FIG. 11, a triangle or an arrow shape can be used instead of the rectangular shape. This embodiment can also be applied similarly to the present pillar spacers located in the frame-shaped BM area 116 shown in FIG. 9. Moreover, it can also be applied similarly to the gradation arrangement of the fifth exemplary embodiment.

### Exemplary Embodiment 7

FIG. 12A is a plan view showing forming areas of the pillar spacers in the LCD panel of a seventh exemplary embodiment of the present invention. FIG. 12B is an enlarged plan view of a forming area 911 at an upper right portion shown in FIG. 12A while FIG. 12C shows an enlarged plan view of a forming area 918 at a middle right portion shown in FIG. 12A.

The pillar spacers of the streamline shape or the water-drop type are formed on an entire CF film in the pixel region 16 of the CF substrate of the LCD panel. As to four forming areas 911 in the pixel region 16 of the panel corner part, the major axis direction of each pillar spacer 901 is arranged so as to be directed toward the seal corner areas. As to four forming areas 918 in the pixel region 16 of each of the panel side part, on the other hand, the major axis direction of each pillar spacer 902 is arranged so as to be parallel to the panel side parts. In this way, even by controlling the arrangement directions of the pillar spacers, it is possible to control the liquid crystal material so that it may spread over the entire panel uniformly.

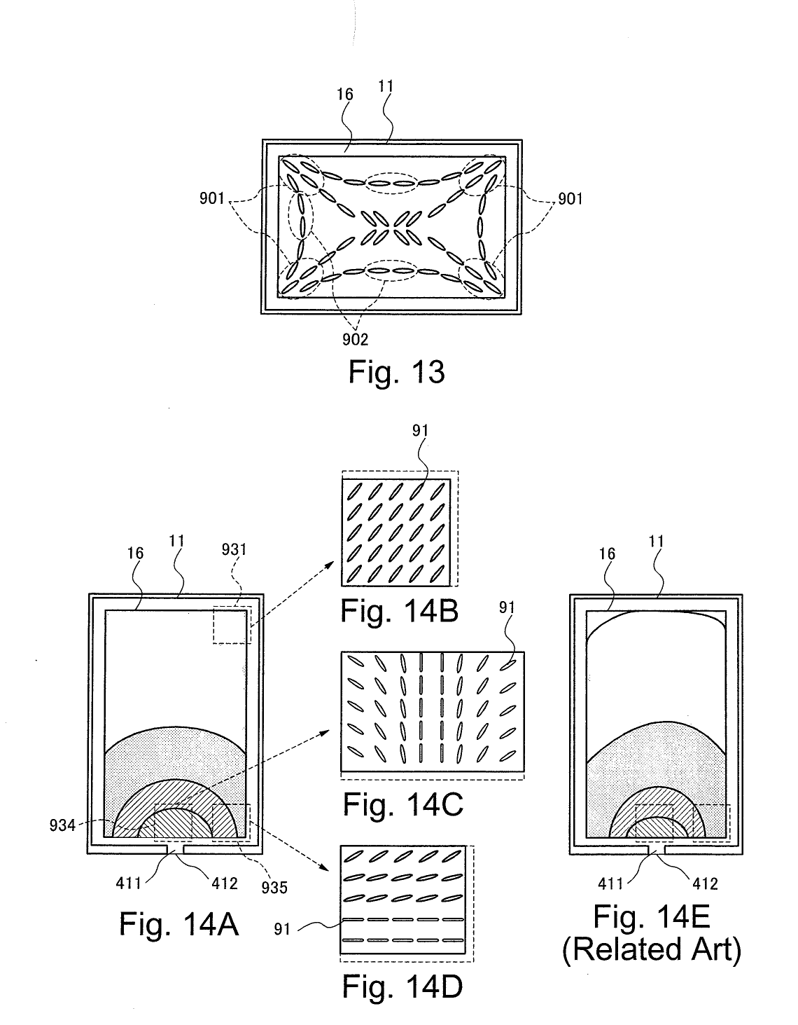

FIG. 13 is a schematic plan view showing a forming area of the pillar spacers 901 and 902 in the LCD panel of the seventh exemplary embodiment of the present invention. In FIG. 13, in order to uniformly spread the liquid crystal material into the entire panel, the major axis directions of the pillar spacers 901 are directed toward the panel corner parts as areas to where the liquid crystal material should be smoothly spread. On the other hand, in such areas that the part (around panel side part center) to where the spread of the liquid crystal material should be delayed, the major axis directions of the pillar spacers 902 are arranged to be parallel with the panel side parts.

In an area between the panel corner part and the vicinity of center of the panel side part, in order to adjust a spreading direction and a spreading rate of the liquid crystal material, the major axis directions of the pillar spacers are arranged so as to be in a direction between “the arrangement direction directed toward the seal corner areas” and “the arrangement direction parallel with the panel side part”.

As for a pattern of the dispensing position of the liquid crystal material, it can be made easier to be spread in a designated direction by dispensing it along the major axis direction of the present pillar spacers as arranged in the aforementioned manner.

In a product arranging the pillar spacers on the frame-shaped BM area between the pixel region and the sealing material, the major axis direction of the pillar spacer can be arranged so as to be directed toward the seal corner area for at least one position of the corner part of the frame-shaped BM area, while the major axis direction of the pillar spacer can be arranged so as to be parallel with the side part for at least one position of the side part of the frame-shaped BM area. Furthermore, the non-repellent treatment of the sixth exemplary embodiment can be applied to the pillar spacers of this exemplary embodiment.

### Exemplary Embodiment 8

FIG. 14A is a plan view showing forming areas of the pillar spacers in the LCD panel of an eighth exemplary embodiment of the present invention. FIG. 14B is an enlarged plan view of a forming area 931 at an upper right portion shown in FIG. 14A. FIG. 14C is an enlarged plan view of a forming area 935 at a lower right portion shown in FIG. 14A. FIG. 14D is an enlarged plan view of a forming area 934 at a vicinity of an opening for injecting liquid crystal material shown in FIG. 14.

On the other hand, FIG. 14E is a plan view showing forming areas of the pillar spacers in a related art for comparison.

In the exemplary embodiments 1 to 7, the disclosed LCD panel is supposed to be fabricated by using the liquid crystal dispenser method, i.e., the panel is assembled by bonding the TFT substrate and the CF substrate together after dispensing the liquid crystal material on either one of them. In FIG. 14A, however, an LCD panel is fabricated by using an injection method, i.e., the panel is assembled by injecting the liquid crystal material into an injection hole of the panel by utilizing vacuum after forming the panel by bonding two substrates. FIG. 14A shows a state that liquid crystal material is injected and spread within the panel. FIG. 14E indicates an LCD panel including conventional pillar spacers and fabricated by using the injection method. FIG. 14E also indicates the state in which the liquid crystal material is injected and spread within the panel for comparing between the panels shown in FIG. 14A and FIG. 14E.

In FIG. 14A, at least either one of the streamline shape pillar spacers or the drop of water type pillar spacers 91 are formed on a CF film in the pixel region 16 of the CF substrate of the LCD panel. On the other hand, in FIG. 14E, the related art rectangular column like, the cylindrical column like or the elliptical pillar spacers are formed on entire CF film in the pixel region of the CF substrate.

Here, in FIG. 14A, the major axis direction of the present pillar spacers are arranged so as to form a fan-shaped pattern opening from the liquid crystal injection hole so that the liquid crystal material spreads over the entire panel smoothly. That is, a round front end of the major axis direction of the pillar spacer is directed toward the injection hole. In FIG. 14A, accordingly, the liquid crystal material spreads uniformly like the fan-shaped pattern in the panel, and thus enabling smooth injection process without deviation in spreading compared with the related art panel shown in FIG. 14E.

As stated above, in the production of the LCD panel by using the injection method, it is possible to control the injection of the liquid crystal material so as to be injected into the entire panel uniformly by controlling the arrangement direction of the pillar spacers to the injection and spread of the liquid crystal material. As a result, injecting time of the liquid crystal material can be reduced. Furthermore, the non-repellent treatment of the sixth exemplary embodiment can be applied to the pillar spacers of this exemplary embodiment.

Although the forming areas and the arrangement directions of the pillar spacers are shown in FIG. 5 through FIG. 14 as examples in the foregoing, the pillar spacers may be formed on the inorganic film or the organic film formed on the driving circuit layer of the TFT substrate or the frame like peripheral area of the TFT substrate instead of the CF substrate.

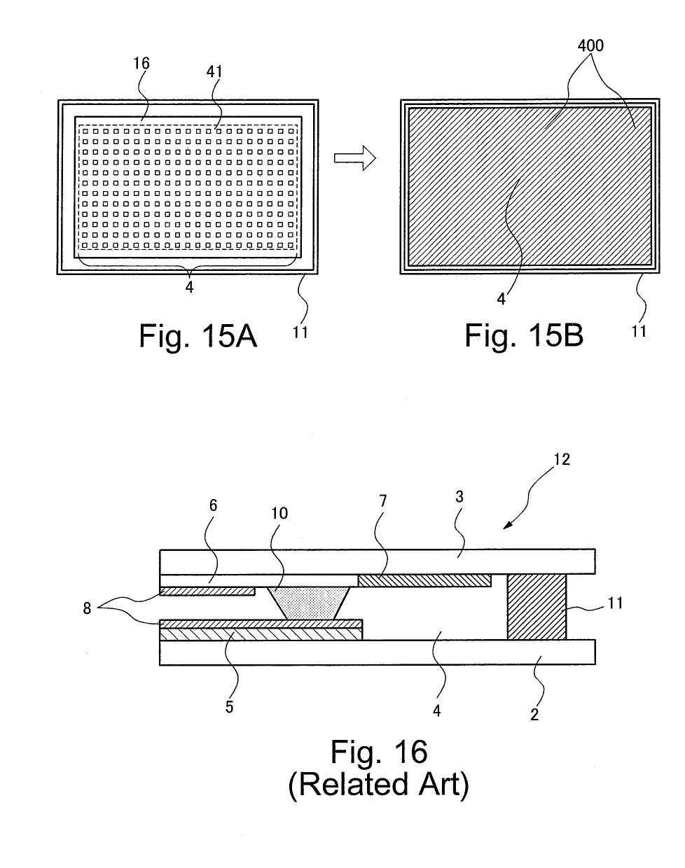

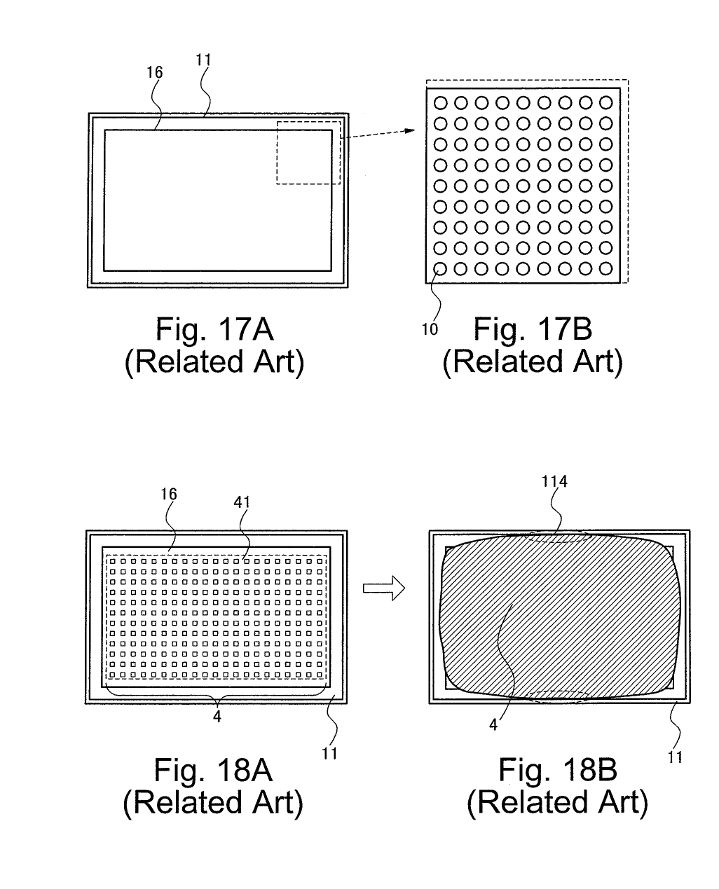

FIG. 15A is a plan view showing a state in the LCD panel of the present invention when two substrates are bonded together after dispensing the liquid crystal material 4. FIG. 15B is a plan view showing a state after the liquid crystal material 4 shown in FIG. 15A spreads.

When the two substrates are bonded together, a dispensing area 41 of the liquid crystal material 4 is filled with the liquid crystal material immediately because adjacent dotted pattern of the liquid crystal material 4 shown in FIG. 15A touches each other within the dispensing area 41. However, it takes time to be filled with the liquid crystal material outside the dispensing area 41. Particularly, in the panel corner part, it takes more time for the liquid crystal material 4 to reach the vicinity of the sealing material 11.

Accordingly, the spread of the liquid crystal material 4 in the coating area of the closed curve-like sealing material 11 can be made uniform as designated by a reference number 400 in FIG. 15B by arranging the pillar spacers in those areas which particularly require time to spread the liquid crystal material as shown in FIG. 5 through FIG. 14. That is, in the pixel region 16 or in both of the pixel region 16 and the frame-shaped BM area at the panel corner part, the major axis direction of the present pillar spacers is directed toward the seal corner area, or arranging the major axis direction of the present pillar spacers parallel with the panel side parts in the pixel region 16 of the panel side parts or in both of the pixel region and the frame-shaped BM area at the panel side parts. As a result, it enables to avoid such problem that the liquid crystal material 4 reaches a partial area of the uncured seal-coated parts and being kept contact with it before performing the UV irradiation after bonding the substrates together.

Furthermore, since the liquid crystal material 4 spreads over the entire panel uniformly by arranging the pillar spacers in the aforementioned manner, a uniform gap can be formed without consuming a stand by time for the bonded substrates. As a result, a waiting time after bonding the substrates can be made short, and thereby shortening a tact time.

Hereinafter, although the present invention is described with reference to examples, unless the point of the present invention is changed, the present invention is not limited to the following examples.

### EXAMPLE 1

The manufacturing method of the LCD device of the IPS mode of the first exemplary embodiment of the present invention is disclosed below. The streamline pillar spacers 91 are arranged in at least one of quadrangle forming areas 911 of the pixel region 16 at the panel corner parts of the CF substrate.

As shown in FIG. 2A and FIG. 2B, each of the streamline pillar spacers 91 has the vertex part 23 on the upper base part which is located on a side of the circular face 20 side, i.e., a side that receives the flow of the liquid crystal material first, displaced from a center of each of the streamline pillar spacers 91.

In a seal coating step for the CF substrate 3 and the TFT substrate 2 after washing and drying for the substrates after such processes as substrate setting through rubbing treatment, a hybrid type sealing material (UV-curable and heat curable) is respectively coated on predetermined positions of the substrates so as to surround a display area of the TFT substrate 2 as a main seal 11 like a closed line and a peripheral seal or an auxiliary seal.

Next, in a liquid crystal dispensing step, predetermined amount of the liquid crystal material 4 is dropped on a predetermined position in a matrix pattern inside the main seal 11. Although the liquid crystal material is dropped in the matrix pattern in this example, that pattern can be designed appropriately according to a product design.

Then, after touching and pressurizing the two substrates in the bonding process, the bonded substrates are kept for a predetermined time. As a result, the liquid crystal material is spread over the entire pixel region, and thereby uniformly forming a gap between the bonded substrates.

And at the time of conveying the bonded substrates to the next step, UV curing is temporarily performed partially for the sealing material 11 at several points as tentative fixing. At that time, when the LCD panel is observed, it is confirmed that the liquid crystal material 4 spreads over the entire panel uniformly without contacting the uncured seal-coated part which is located at a shortest distance from the liquid crystal dispensing points.

In the next UV curing step after the temporary UV curing process, the sealing material 11 is cured by UV irradiation dose of 3000 mJ. And next, in a heat curing step, the sealing material 11 is totally cured by heating it at 120° C. for one hour.

After completing the heat curing, a gap measurement is performed for a display area and the vicinity of the frame-shaped BM 7 of the LCD panel 1. As a result, it can be confirmed that a uniform gap is obtained at the entire area of the display part.

The LCD device of the example of the present invention fabricated in this way is subjected to a high-humidity/temperature test. When a driving test is performed for the LCD panel under the environment with temperature of 60° C. and the humidity of 60% for 1500 hours, it can be confirmed that it is a good display state without occurrence of stains and unevenness in the vicinity of the seal part of the LCD panel.

### EXAMPLE 2

The manufacturing method of the LCD device of the TN mode of the second exemplary embodiment of the present invention is disclosed below. As shown in FIG. 7B, the streamline pillar spacers are arranged in two triangle forming areas 912 of pixel region 16 of the panel corner part of the CF substrate opposing to the panel corner part which is located on an extended direction 72 crossing a rubbing direction 70 of the TFT substrate.

As shown in FIG. 2A and FIG. 2B, each of the streamline pillar spacers 91 has the vertex part 23 on the upper base part which is located on a side of the circular face 20 side, i.e., a side that receives the flow of the liquid crystal material first, displaced from a center of each of the streamline pillar spacers 91.

In a seal coating step for the CF substrate 3 and the TFT substrate 2 after washing and drying for the substrates after such processes as substrate setting through rubbing treatment, a hybrid type sealing material (UV-curable and heat curable) is respectively coated on predetermined positions of the substrates so as to surround a display area of the TFT substrate 2 as a main seal 11 like a closed line and a peripheral seal (auxiliary seal).

Successively, in an Ag (silver) application step, the Ag transfer-electrodes are provided on predetermined positions of the TFT substrate in a dotted pattern. Next, in a liquid crystal dispensing step, predetermined amount of the liquid crystal material 4 is dropped on a predetermined position in a matrix pattern inside the main seal 11.

Then, after touching and pressurizing the two substrates in the bonding process, the bonded substrates are kept for a predetermined time. As a result, the liquid crystal material is spread over the entire pixel region, and thereby uniformly forming a gap between the bonded substrates.

And at the time of conveying the bonded substrates to the next step, UV curing is temporarily performed partially for the sealing material 11 at several points as tentative fixing. At that time, when the LCD panel is observed, it is confirmed that the liquid crystal material 4 spreads over the entire panel uniformly without contacting a part which is located at a shortest distance from the frame like peripheral area among the uncured seal-coated part.

In the next UV curing step after the temporary UV curing process, the sealing material 11 is cured by UV irradiation dose of 3000 mJ. And next, in a heat curing step, the sealing material 11 is totally cured by heating it at 120° C. for one hour.

After completing the heat curing, a gap measurement is performed for a display area and the vicinity of the frame-shaped BM 7 of the LCD panel 1. As a result, it can be confirmed that a uniform gap is obtained at the entire area of the display part.

The LCD device of the example of the present invention fabricated in this way is subjected to a high-humidity/temperature test. When a driving test is performed for the LCD panel under the environment with temperature of 60° C. and the humidity of 60% for 1500 hours, it can be confirmed that it is a good display state without occurrence of stains and unevenness in the vicinity of the seal part of the LCD panel.

### EXAMPLE 3

The manufacturing method of the LCD device of the IPS mode of the third exemplary embodiment of the present invention is disclosed below. The streamline pillar spacers are arranged in four quadrangle forming areas 911 of the pixel region 16 at the panel corner parts of the CF substrate as shown in FIG. 8A.

As shown in FIG. 2A and FIG. 2B, each of the streamline pillar spacers has the vertex part 23 on the upper base part which is located on a side of the circular face 20 side, i.e., a side that receives the flow of the liquid crystal material first, displaced from a center of each of the streamline pillar spacers 91.

In a seal coating step for the CF substrate 3 and the TFT substrate 2 after washing and drying for the substrates after such processes as substrate setting through rubbing treatment, a hybrid type sealing material (UV-curable and heat curable) is respectively coated on predetermined positions of the substrates so as to surround a display area of the TFT substrate 2 as a main seal 11 like a closed line and an auxiliary seal.

Next, in a liquid crystal dispensing step, predetermined amount of the liquid crystal material 4 is dropped on a predetermined position in a matrix pattern inside the main seal 11. Then, after touching and pressurizing the two substrates in the bonding process, the bonded substrates are kept for a predetermined time. As a result, the liquid crystal material is spread over the entire pixel region, and thereby uniformly forming a gap between the bonded substrates.

And at the time of conveying the bonded substrates to the next step, UV curing is temporarily performed partially for the sealing material 11 at several points as tentative fixing. At that time, when the LCD panel is observed, it is confirmed that the liquid crystal material 4 spreads over the entire panel uniformly without contacting the uncured seal-coated part which is located at a shortest distance from the liquid crystal dispensing points.

In the next UV curing step after the temporary UV curing process, the sealing material 11 is cured by UV irradiation dose of 3000 mJ. And next, in a heat curing step, the sealing material 11 is totally cured by heating it at 120° C. for one hour.

After completing the heat curing, a gap measurement is performed for a display area and the vicinity of the frame-shaped BM 7 of the LCD panel 1. As a result, it can be confirmed that a uniform gap is obtained at the entire area of the display part.

The LCD device of the example of the present invention fabricated in this way is subjected to a high-humidity/temperature test. When a driving test is performed for the LCD panel under the environment with temperature of 60° C. and the humidity of 60% for 1500 hours, it can be confirmed that it is a good display state without occurrence of stains and unevenness in the vicinity of the seal part of the LCD panel.

### EXAMPLE 4

The manufacturing method of the LCD device of the IPS mode of the fourth exemplary embodiment of the present invention is disclosed below. The streamline pillar spacers 91 are arranged in arrow-shaped forming areas 914 of the pixel region 16 at the panel corner parts of the CF substrate as shown in FIG. 9. Moreover, the streamline pillar spacers 91 are also arranged in the “L” type forming areas 914 of four corners in the frame-shaped BM areas 116 as shown in FIG. 9B.

As shown in FIG. 2A and FIG. 2B, each of the streamline pillar spacers 91 has the vertex part 23 on the upper base part which is located on a side of the circular face 20 side, i.e., a side that receives the flow of the liquid crystal material first, displaced from a center of each of the streamline pillar spacers 91.

In a seal coating step for the CF substrate 3 and the TFT substrate 2 after washing and drying for the substrates after such processes as substrate setting through rubbing treatment, a hybrid type sealing material (UV-curable and heat curable) is respectively coated on predetermined positions of the substrates so as to surround a display area of the TFT substrate 2 as a main seal 11 like a closed line and an auxiliary seal.

Next, in a liquid crystal dispensing step, predetermined amount of the liquid crystal material 4 is dropped on a predetermined position in a matrix pattern inside the main seal 11. Then, after touching and pressurizing the two substrates in the bonding process, the bonded substrates are kept for a predetermined time. As a result, the liquid crystal material is spread over the entire pixel region, and thereby uniformly forming a gap between the bonded substrates.

And at the time of conveying the bonded substrates to the next step, UV curing is temporarily performed partially for the sealing material 11 at several points as tentative fixing. At that time, when the LCD panel is observed, it is confirmed that the liquid crystal material 4 spreads over the entire panel uniformly without contacting the uncured seal-coated part which is located at a shortest distance from the liquid crystal dispensing points.

In the next UV curing step after the temporary UV curing process, the sealing material 11 is cured by UV irradiation dose of 3000 mJ. And next, in a heat curing step, the sealing material 11 is totally cured by heating it at 120° C. for one hour.

After completing the heat curing, a gap measurement is performed for a display area and the vicinity of the frame-shaped BM 7 of the LCD panel 1. As a result, it can be confirmed that a uniform gap is obtained at the entire area of the display part.

The LCD device of the example of the present invention fabricated in this way is subjected to a high-humidity/temperature test. When a driving test is performed for the LCD panel under the environment with temperature of 60° C. and the humidity of 60% for 1500 hours, it can be confirmed that it is a good display state without occurrence of stains and unevenness in the vicinity of the seal part of the LCD panel.

### EXAMPLE 5

The manufacturing method of the LCD device of the IPS mode of the fifth exemplary embodiment of the present invention is disclosed below. This LCD panel has a narrow frame like peripheral area configuration, and it requires controlling the spread of the liquid crystal material around the frame like peripheral area delicately. Therefore, as shown in FIG. 10, the shape of the spacers changes from the water-drop type to another water-drop type with thin width along its minor axis direction, and then, further to the streamline shape in each of the quadrangle areas 911 at four corners within the pixel region 16 of the CF substrate.

As shown in FIG. 2A and FIG. 2B, each of the water-drop type pillar spacers 92 or the streamline pillar spacers 91 has the vertex part 23 on the upper base part which is located on a side of the circular face 20 side, i.e., a side that receives the flow of the liquid crystal material first, displaced from a center of each of the pillar spacers 91 and 92.

In a seal coating step for the CF substrate 3 and the TFT substrate 2 after washing and drying for the substrates after such processes as substrate setting through rubbing treatment, a hybrid type sealing material (UV-curable and heat curable) is respectively coated on predetermined positions of the substrates so as to surround a display area of the TFT substrate 2 as a main seal 11 like a closed line and an auxiliary seal.

Next, in a liquid crystal dispensing step, predetermined amount of the liquid crystal material 4 is dropped on a predetermined position in a matrix pattern inside the main seal 11. Then, after touching and pressurizing the two substrates in the bonding process, the bonded substrates are kept for a predetermined time. As a result, the liquid crystal material is spread over the entire pixel region, and thereby uniformly forming a gap between the bonded substrates.

And at the time of conveying the bonded substrates to the next step, UV curing is temporarily performed partially for the sealing material 11 at several points as tentative fixing. At that time, when the LCD panel is observed, it is confirmed that the liquid crystal material 4 spreads over the entire panel uniformly without contacting the uncured seal-coated part which is located at a shortest distance from the liquid crystal dispensing points.

In the next UV curing step after the temporary UV curing process, the sealing material 11 is cured by UV irradiation dose of 3000 mJ. And next, in a heat curing step, the sealing material 11 is totally cured by heating it at 120° C. for one hour.

After completing the heat curing, a gap measurement is performed for a display area and the vicinity of the frame-shaped BM 7 of the LCD panel 1. As a result, it can be confirmed that a uniform gap is obtained at the entire area of the display part.

The LCD device of the example of the present invention fabricated in this way is subjected to a high-humidity/temperature test. When a driving test is performed for the LCD panel under the environment with temperature of 60° C. and the humidity of 60% for 1500 hours, it can be confirmed that it is a good display state without occurrence of stains and unevenness in the vicinity of the seal part of the LCD panel.

### EXAMPLE 6

The manufacturing method of the LCD device of the VA mode of the sixth exemplary embodiment of the present invention is disclosed below. The streamline pillar spacers are arranged in four quadrangle forming areas 911 of the pixel region 16 at the panel corner parts of the CF substrate as shown in FIG. 8A.

As shown in FIG. 2A and FIG. 2B, each of the streamline pillar spacers 91 has the vertex part 23 on the upper base part which is located on a side of the circular face 20 side, i.e., a side that receives the flow of the liquid crystal material first, displaced from a center of each of the streamline pillar spacers 91.

First, in the step of setting substrate and washing and drying, the CF substrate and the TFT substrate are washed and dried in order to clean their surfaces. After this, on the CF substrate, the plasma processing is performed in a pinpoint manner for the forming area 911 of the streamline pillar spacers just before forming the alignment film, and thereby providing the non-repellent treatment on the pillar spacer surface of this area 911. After that treatment, a contact angle measurement is carried out for the forming area of the streamline pillar spacers with the liquid crystal material to be enclosed in the LCD panel of the present invention by using a contact angle measuring apparatus made of Kyowa Surface Science Co., Ltd. As a result, it can be confirmed that 10 degrees or less for the non-repellency of the liquid crystal material.

After that, in a seal coating step for the CF substrate and the TFT substrate after washing and drying for the substrates passed through such processes as alignment film printing and baking, a hybrid type sealing material (UV-curable and heat curable) is respectively coated on predetermined positions of the substrates so as to surround a display area of the TFT substrate 2 as a main seal 11 like a closed line and an auxiliary seal.

Next, in a liquid crystal dispensing step, predetermined amount of the liquid crystal material 4 is dropped on a predetermined position in a matrix pattern inside the main seal 11. Then, after touching and pressurizing the two substrates in the bonding process, the bonded substrates are kept for a predetermined time. As a result, the liquid crystal material is spread over the entire pixel region, and thereby uniformly forming a gap between the bonded substrates.

And at the time of conveying the bonded substrates to the next step, UV curing is temporarily performed partially for the sealing material 11 at several points as tentative fixing. At that time, when the LCD panel is observed, it is confirmed that the liquid crystal material 4 spreads over the entire panel uniformly without contacting the uncured seal-coated part which is located at a shortest distance from the liquid crystal dispensing points.

In the next UV curing step after the temporary UV curing process, the sealing material 11 is cured by UV irradiation dose of 3000 mJ. And next, in a heat curing step, the sealing material 11 is totally cured by heating it at 120° C. for one hour.

After completing the heat curing, a gap measurement is carried out for a display area and the vicinity of the frame-shaped BM 7 of the LCD panel 1. As a result, it is confirmed that a uniform gap is obtained at the entire area of the display part.

The LCD device of the example of the present invention fabricated in this way is subjected to a high-humidity/temperature test. When a driving test is carried out for the LCD panel under the environment with temperature of 60° C. and the humidity of 60% for 1500 hours, it can be confirmed that it is a good display state without occurrence of stains and unevenness in the vicinity of the seal part of the LCD panel.

### EXAMPLE 7

The manufacturing method of the LCD device of the IPS mode of the seventh exemplary embodiment of the present invention is disclosed below. The streamline pillar spacers are arranged on the entire area of the CF film in the pixel region of the CF substrate.

As shown in FIG. 2A and FIG. 2B, each of the streamline pillar spacers 91 has the vertex part 23 on the upper base part which is located on a side of the circular face 20 side, i.e., a side that receives the flow of the liquid crystal material first, displaced from a center of each of the streamline pillar spacers 91.

As to four forming areas 911 in the pixel region 16 of the panel corner part, the major axis direction of each pillar spacer 901 is arranged so as to be directed toward the seal corner area. As to four forming areas 918 in the pixel region 16 of each of the panel side part, on the other hand, the major axis direction of each pillar spacer 902 is arranged so as to be parallel to the panel side part.

In a seal coating step for the CF substrate and the TFT substrate after washing and drying for the substrates after such processes as substrate setting through rubbing treatment, a hybrid type sealing material (UV-curable and heat curable) is respectively coated on predetermined positions of the substrates so as to surround a display area of the TFT substrate 2 as a main seal 11 like a closed line and an auxiliary seal.

Next, in a liquid crystal dispensing step, predetermined amount of the liquid crystal material 4 is dropped on predetermined positions in a matrix pattern inside the main seal 11. Then, after touching and pressurizing the two substrates in the bonding process, the bonded substrates are kept for a predetermined time. As a result, the liquid crystal material is spread over the entire pixel region, and thereby uniformly forming a gap between the bonded substrates.

And at the time of conveying the bonded substrates to the next step, UV curing is temporarily performed partially for the sealing material 11 at several points as tentative fixing. At that time, when the LCD panel is observed, it is confirmed that the liquid crystal material 4 spreads over the entire panel uniformly without contacting the uncured seal-coated part which is located at a shortest distance from the liquid crystal dispensing points.

In the next UV curing step after the temporary UV curing process, the sealing material 11 is cured by UV irradiation dose of 3000 mJ. And next, in a heat curing step, the sealing material 11 is totally cured by heating it at 120° C. for one hour.

After completing the heat curing, a gap measurement is carried out for a display area and the vicinity of the frame-shaped BM 7 of the LCD panel 1. As a result, it can be confirmed that a uniform gap is obtained at the entire area of the display part.

The LCD device of the example of the present invention fabricated in this way is subjected to a high-humidity/temperature test. When a driving test is performed for the LCD panel under the environment with temperature of 60° C. and the humidity of 60% for 1500 hours, it can be confirmed that it is a good display state without occurrence of stains and unevenness in the vicinity of the seal part of the LCD panel.

### EXAMPLE 8

The manufacturing method of the LCD device of the IPS mode of the eighth exemplary embodiment of the present invention is disclosed below. The eighth exemplary embodiment is applied to the LCD panel fabricated by using an injection method. The streamline pillar spacers are arranged on the entire area of the CF film in the pixel region of the CF substrate. As shown in FIG. 14A, the major axis direction of the present pillar spacers are arranged so as to form a fan-shaped pattern opening from the liquid crystal injection hole so that the liquid crystal material spreads over the entire panel smoothly.

As shown in FIG. 2A and FIG. 2B, each of the streamline pillar spacers 91 has the vertex part 23 on the upper base part which is located on a side of the circular face 20 side, i.e., a side that receives the flow of the liquid crystal material first, displaced from a center of each of the streamline pillar spacers 91.

In a seal coating step for the CF substrate and the TFT substrate after washing and drying for the substrates after such processes as substrate setting through rubbing treatment, a hybrid type sealing material (UV-curable and heat curable) is respectively coated on predetermined positions of the substrates so as to surround a display area of the TFT substrate 2 as a main seal 11 like a closed line and an auxiliary seal.

Next, the sealing material is cured in a condition that the gap between the substrates is maintained so as to be the same height of the pillar spacers by successively performing a temporary baking process (pre-baking) at 90° C., a bonding process of two substrates with heat pressurization at 110° C., and a final baking process (post-baking) at 150° C.

And in a next liquid crystal injection step, after subjecting a the panel drying process, the liquid crystal material is injected into the injection hole for the liquid crystal so that the liquid crystal material is sandwiched between the substrates and thereby uniformly forming the gap. At that time, when the LCD panel filled with the liquid crystal material is observed, it is confirmed that the liquid crystal material is spread over the entire panel uniformly despite of a short injecting time.

Next, in a UV irradiation step for sealing the injection hole for liquid crystal material, the injection hole is coated with a sealer of a UV curable type, and then irradiated with UV to totally cure the sealer.

After that, a gap measurement is performed for a display area and the vicinity of the frame-shaped BM 7 of the LCD panel 1 after being subjected to a panel cleaning step and an annealing process step. As a result, it can be confirmed that a uniform gap is obtained at the entire area of the display part without generating air bubble.

A liquid crystal display device according to another exemplary aspect of the invention includes a pair of rectangular substrates, liquid crystal material, a sealing member and pillar spacers. The rectangular substrates are provided with an alignment film respectively and the liquid crystal material is disposed between the substrates. The sealing member is provided between the substrates for sealing the liquid crystal material. The pillar spacers are provided on either one of the substrates and the pillar spacers includes asymmetric pillar spacers each having a major axis and a minor axis viewed from a normal direction of the substrates with a rear end made sharply than a front end of the major axis. The asymmetric pillar spacers are arranged on pixel regions in vicinity of four corners of one of the rectangular substrates so that the rear end in a direction of the major axis is directed toward the corners while the asymmetric pillar spacers are arranged on pixel regions in vicinity of four sides of one of the rectangular substrates so that the major axis is parallel to the sides, respectively.

A liquid crystal display device according to further exemplary aspect of the invention includes a pair of rectangular substrates, injected liquid crystal material, a sealing member at injection hole portion, and pillar spacers. The rectangular substrates are provided with an alignment film respectively and the liquid crystal material is disposed between the substrates. The sealing member is provided between the substrates for sealing the liquid crystal material. The sealing member is provided on the injection hole for the injected liquid crystal material. The pillar spacers are provided on either one of the substrates and the pillar spacers includes asymmetric pillar spacers each having a major axis and a minor axis viewed from a normal direction of the substrates with a rear end made sharply than a front end of the major axis. The asymmetric pillar spacers are arranged so that the rear end in a direction of the major axis is directed toward the injection hole.

Regarding the pillar spacers formed on the pixel region of the CF substrate or the TFT substrate of the LCD panel, asymmetric pillar spacers are arranged such that its major axis direction is directed toward the seal corner area in the pixel region or in both of the pixel region and the frame-shaped BM area at the panel corner parts where the arrival time of the liquid crystal material to the seal-coated area is long, i.e., the panel corner parts require time in particular for the spread of the liquid crystal material while the asymmetric pillar spacers are arranged in the pixel region or in both of the pixel region and the frame-shaped BM area at the panel side part so that its major axis direction is arranged parallel with the panel side part.

Each of the pillar spacers has a shape of streamline shape or drop of water type, and they are arranged at the panel corner parts or the panel side parts at least one of inside of the pixel region or in the frame-shaped BM area. Accordingly, compared with the case using such pillar spacers as the rectangular column like, the cylindrical column like or the ellipse, it is possible to control the liquid crystal material so as to spread over smoothly along the spacer surface without being obstructed by the spacer itself in such parts where the liquid crystal material is desired to spread over smoothly. It is also possible to control the liquid crystal material so as to be obstructed by the spacer itself in such parts where the spread of the liquid crystal material is desired to be delayed. That is, when setting the arrangement direction of the pillar spacers appropriately for each part in which the pillar spacers are arranged, the spreading direction and the spreading rate of the liquid crystal material can be controlled, and the liquid crystal material can be spread into the entire panel uniformly.

Accordingly, it is possible to prevent the display defect due to contact between the liquid crystal material and the uncured sealing material caused by the difference in the arrival time of the liquid crystal material inside the closed-line shape of the seal coated area. Since the liquid crystal material spreads over the entire panel uniformly, the waiting time after bonding the substrates can be made short, and thereby shortening a tact time.

The present invention can be applied to the LCD panel using the pillar spacers with the IPS (In Plane Switching) mode and the TN (Twisted Nematic) mode in general, and particularly providing a large advantage for the LCD panel with the VA (Vertical Alignment) mode in which the spread of the liquid crystal material is extremely slow. As a result, it enables to provide the LCD device with extremely improved reliability.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

What is claimed is:

1. A liquid crystal display device, comprising:
a pair of substrates having an alignment film respectively;
a liquid crystal material disposed between said pair of substrates;
a sealing member provided between said pair of substrates for sealing said liquid crystal material; and
a plurality of pillar spacers provided on either one of said pair of substrates, said pillar spacers including asymmetric pillar spacers each having a major axis and a minor axis viewed from a normal direction of said pair of substrates with a round front end and a sharp rear end of said major axis, wherein said asymmetric pillar spacers are arranged on a pixel region in a vicinity of at least one corner of one of said pair of substrates so that said rear end in a direction of said major axis is directed toward said corner.

2. The liquid crystal display device according to claim 1, wherein said asymmetric pillar spacers are arranged on pixel regions in vicinity of two corners among four corners of one of said pair of substrates such that said two corners are located on an extended direction of a diagonal, which is one of two diagonals crossing a rubbing direction of said alignment film with a larger crossing angle between them.

3. The liquid crystal display device according to claim 1, wherein said asymmetric pillar spacers are arranged on pixel regions in vicinity of four corners of one of said pair of substrates.

4. The liquid crystal display device according to claim 1, wherein a shape of area arranged with said asymmetric pillar spacers is one of those selected from a triangle having vertices located on a corner of said pixel region and two sides extended therefrom, a rectangle having vertices respectively located on a corner of said pixel region and two sides extended therefrom and inside of said pixel region, and an arrow-shaped one having vertices located on a corner of said pixel region and two sides extended therefrom and inside of said pixel region so that said vertex opposing to said corner of the pixel region is arranged such that it is located closer to the corner of said pixel region than a line connecting two vertices on said both sides of the pixel region.

5. The liquid crystal display device according to claim 1, wherein said asymmetric pillar spacers are also arranged on a frame like peripheral area located outside of said pixel region and inside of said sealing member in vicinity of at least one corner of one of said pair of substrates so that said rear end in said direction of said major axis is also directed toward said corner.

6. The liquid crystal display device according to claim 5, wherein a shape of area arranged with said asymmetric pillar spacers is one of those selected from a hexagon with capital letter “L” like shape having vertices respectively located on a corner of said pixel region and two sides extended therefrom and three positions outside of said pixel region, and an arrow-shaped one having vertices respectively located on a corner of said pixel region and two sides extended therefrom and three positions outside of said pixel region so that said vertex opposing to said corner of said pixel region is made acute angle.

7. The liquid crystal display device according to claim 1, wherein each of said asymmetric pillar spacers has a shape of selected one from a streamline type and a drop of water type.

8. The liquid crystal display device according to claim 7, wherein shapes of said asymmetric pillar spacers change from said drop of water type to said streamline type gradually from inside to outside of said one of said pair of substrates.

9. The liquid crystal display device according to claim 1, wherein said pillar spacers have surfaces which are non-repellent to said liquid crystal material.

10. A liquid crystal display device, comprising:
a pair of rectangular substrates provided with an alignment film respectively;
a liquid crystal material disposed between said pair of rectangular substrates;
a sealing member provided between said pair of rectangular substrates for sealing said liquid crystal material; and
a plurality of pillar spacers provided on either one of said pair of rectangular substrates, said pillar spacers including asymmetric pillar spacers each having a major axis and a minor axis viewed from a normal direction of said pair of substrates with a rear end made sharply than a front end of said major axis, wherein said asymmetric pillar spacers are arranged on pixel regions in vicinity of four corners of one of said pair of rectangular substrates so that said rear end in a direction of said major axis is directed toward said corners while said asymmetric pillar spacers are arranged on pixel regions in vicinity of four sides of one of said pair of rectangular substrates so that said major axis is parallel to said sides, respectively.

11. The liquid crystal display device according to claim 10, wherein each of said asymmetric pillar spacers has a shape of selected one from a streamline type and a drop of water type.

12. The liquid crystal display device according to claim 11, wherein shapes of said asymmetric pillar spacers change from said drop of water type to said streamline type gradually from inside to outside of said one of said pair of substrates.

13. The liquid crystal display device according to claim 10, wherein said pillar spacers have surfaces which are non-repellent to said liquid crystal material.

14. A liquid crystal display device, comprising:
a pair of rectangular substrates provided with an alignment film respectively;
a liquid crystal material injected between said pair of rectangular substrates;
a sealing member provided between said pair of rectangular substrates for sealing said liquid crystal material, said sealing member being provided with an inlet portion for injected liquid crystal material; and
a plurality of pillar spacers provided on either one of said pair of rectangular substrates, said pillar spacers including asymmetric pillar spacers each having a major axis and a minor axis viewed from a normal direction of said pair of substrates with a rear end made sharply than a front end of said major axis, wherein said asymmetric pillar spacers are arranged so that said rear end in a direction of said major axis is directed toward said inlet portion.

15. The liquid crystal display device according to claim 14, wherein each of said asymmetric pillar spacers has a shape of selected one from a streamline type and a drop of water type.

16. The liquid crystal display device according to claim 15, wherein shapes of said asymmetric pillar spacers change from said drop of water type to said streamline type gradually from inside to outside of said one of said pair of substrates.

17. The liquid crystal display device according to claim 14, wherein said pillar spacers have surfaces which are non-repellent to said liquid crystal material.
